(19) United States
(12) Patent Application Publication
(10) Pub. No.: US 2015/0213540 A1
(43) Pub. Date: Jul. 30, 2015

(54) APPARATUS, METHODS AND ARTICLES OF MANUFACTURE FOR EXTRACTING, PROVIDING AND REVIEWING DATA

(71) Applicants: Sean Wolfington, Key Biscayne, FL (US); Scott Davis, Cedar Falls, IA (US)

(72) Inventors: Sean Wolfington, Key Biscayne, FL (US); Scott Davis, Cedar Falls, IA (US)

(21) Appl. No.: 14/168,448

(22) Filed: Jan. 30, 2014

(51) Int. Cl. G06Q 30/06

(52) U.S. Cl. CPC G06Q 30/0629; G06Q 30/0627

(57) ABSTRACT

Apparatus, methods and articles of manufacture are shown, for providing vehicle cost structure data to buyers and sellers.

### BACKGROUND

Extracting, providing and reviewing data in the course of potential vehicle acquisition can be a challenging undertaking There are many cost and other considerations, from cost of ownership (which may include variables such as lease and/or financing costs, gas, repair, etc.) to the attractiveness of a newer car. The potential buyer of any vehicle may desire as much information as possible, to help inform any possible acquisition, however, information may be difficult to provide to the buyer in a useful, convenient format.

One of the challenges is that a buyer may simply be unaware that a newer vehicle may be cheaper than the one the buyer currently has, due to any number of factors (e.g., manufacturer's pricing, incentives, interest rates, etc.) Variables such as more favorable financing, better gas mileage and hence lower amounts spent on gas, low or no repair costs on a new vehicle etc. may, when totaled, provide the buyer with a less expensive alternative than his or her present vehicle, but providing comparison information to a buyer in a simple, useful and convenient format, through any number of platforms, may be difficult, time consuming and cost prohibitive, especially when attempting to provide such information to a number of buyers.

### SUMMARY

Embodiments herein provide vehicle cost structure data, at desired intervals, and/or on-demand. Embodiments may use one or more data sources, such as a manufacturer's database, a third party database, a financing entity database, etc., in the course of providing the data.

The data is provided in various forms and formats to any interested party. An interested parties may include for example, a seller (e.g. a manufacturer, car dealer, sales person, etc.), and/or a buyer (e.g., a fleet owner, individual, etc.) (“Buyer” is defined herein to include a leasee.)

Various forms and formats include those as known in the art for display of data. For example, embodiments may provide a total monthly cost for a potential buyer's current vehicle, utilizing such data as financing amount, from a financing database, gas cost based on the vehicle's mpg, from a manufacturer's database, repair cost based on repair estimates from a third party consumer database, etc. and compare that total monthly cost to another vehicle or vehicles that have a lower monthly cost than a potential buyer's current vehicle, and do so using display, print, etc. media, as is known in the art. For example, embodiments may provide a dealer with all customers in a given group and/or database that can get a new car for the same or less monthly cost as their current car.

### BRIEF DESCRIPTION OF THE DRAWINGS

FIG. 1 shows a block view of an embodiment.

FIG. 2 shows a flow chart of an embodiment.

### DETAILED DESCRIPTION OF EMBODIMENTS

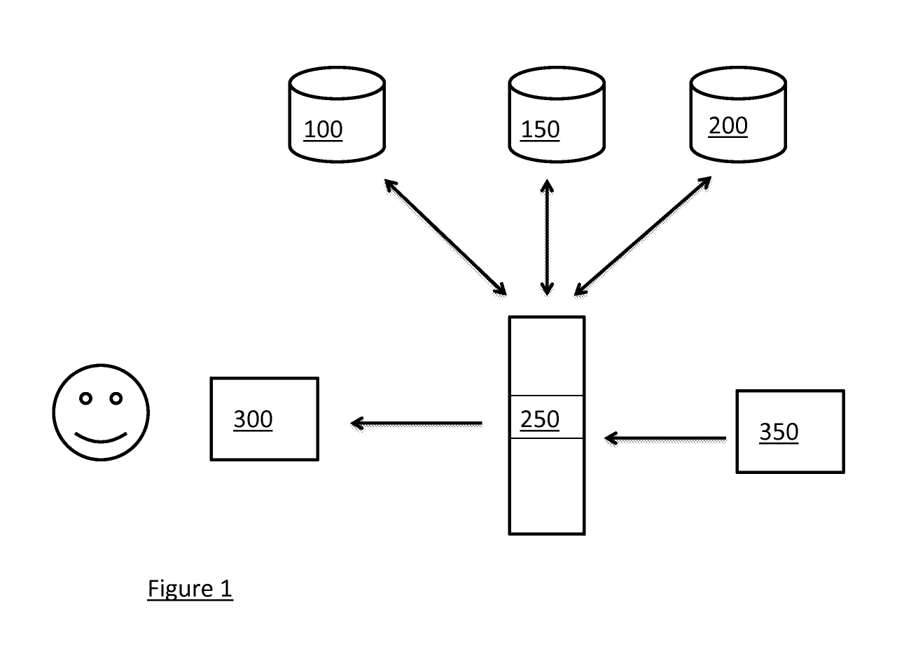

Turning to FIG. 1, an embodiment is shown. Database 100 is for providing data on potential buyers as desired. In this embodiment, the potential buyers are registered owners of a specific manufacturer's vehicle model, so for example, registrants of Company X's Vehicle Y. In various embodiments, this database may be comprised of any desired type or any number of types of potential buyers, for example, all previous customers of a dealership, registered owners within a state and/or other geographic area, prior customers of a financing entity, information provided by Polk or data providers, etc.

Embodiments may as well, have other information as desired in these or other databases (not shown here) on potential buyers and/or their present vehicles. For example, year, make, model, trim level, present vehicle wholesale and/or retail value, operating costs, for example, gas, repair costs, insurance, etc., level of indicated interest in moving to a newer model, prior purchase and/or lease history, (e.g., frequency, models, income, etc.) A database may also be desired wherein customers are self added, that is, where customers may add their own information as desired to ensure inclusion in subsequent processing as is described herein.

These databases may be viewed as “buyer side” databases providing information (used interchangeably herein with “data”) as desired on potential buyers, their vehicles, finances, etc.

Also present in various embodiments are what may be viewed as “seller side” databases which are for providing information other than buyer side information. For example, database 150 is for providing potential new vehicle model identification information, which may include name, model types, manufacturer, year, etc. as desired. Database 200 is for providing data on cost and other variables related to vehicles present in database 150, such as for example, cost, retail and other (fleet, wholesale, incentivized, desired sales etc.) price, leasing costs, residuals, rental costs, length, interest rates and other financing alternatives, length of warranty, optional warranties, anticipated gas costs, anticipated repair costs, reliability information, anticipated insurance costs, etc. As has been described above, there may be more than one database, so that for example, in various embodiments, prices may be in a third party manufacturer's database, another database may be for providing other data, (e.g., for providing a third party's data, with third parties comprising commercial providers, e.g., Edmond's, Consumer Reports, AAA, etc., an appropriate governmental body, for providing government and/or other data, e.g., geographic cost data, fuel cost data, safety data including crash worthiness, future projection data, manufacturer and other supply chain providers, etc. Another embodiment might provide yet other database with dealership data, so that, for example, a dealer may have an embodiment that provides to a customer a printout, email or the like, delivered via a customer delivery channel as is known in the art, e.g., printout and hand delivery, email, promotional mailing, etc. Buyer side and seller side databases may further comprise one or more third party databases.

It should be noted that, in various embodiments, “database” as used herein may include any type or number of data stores and/or sources as known in the art, e.g., data warehouses, data marts, operational datastores, local databases, content aggregators, web services, raw data, real time data, line data feed from sensors and the like, raw data generators, and other mechanisms, manipulated (which term includes analyzed and collected) data, data from manual or other input, and as otherwise known in the art, and any or all of the data stores and/or sources are local, networked, available through a distributed architecture, server side, client side, as otherwise known in the art, etc.

A server in various embodiments is for providing access to the data held in the databases and/or analyzes and/or utilizes said data, such as through local storage and use, building and maintaining those and other databases, building output for user use, and other server uses as known in the art etc. So for example, server 250 provides access to the databases shown, provides analysis of the data if desired, and, as well, builds its own local databases for reference. Server 250, for example, may be used to access database 100 for potential buyers who own, lease or finance Company X's Vehicle Y, which is less than three years old; and, as well, access database 150 for the newest version of the same or similar model or models as desired, and access database 200 for cost information for the model or models provided by database 150, so that each cost structure—that of the older vehicle versus newer—can be reviewed.

Embodiments may use averages for cost variables and/or individual costs and/or other particular costs as desired. So for example embodiments may provide cost numbers for repairs based on a geographic analysis for a particular buyer, and/or cost numbers for an average nationwide cost or other basis, etc.

Embodiments may also provide for particularized buyer costs as well as typical buyer costs for an existing owned, leased or financed vehicle. So for example, a display may be provided to a buyer who leases a vehicle without buyer input of any personalized information beyond vehicle, year and lease terms. Embodiments may also provide for personalized information in whole or part as well. For example, the level of buyer equity could be input as desired, and a buyer with equity could be shown a comparison based on application of that equity to new vehicle. For example, a buyer with a financed vehicle who has no or negative equity, may input such information, and an output may be shown with vehicles that would cost the buyer less than his or her current payments. For example, a buyer may have a certain driving pattern and such could be utilized as well in generating vehicle cost structure comparison data.

Embodiments may also consider the use of a down payment (“out of pocket money”) of one of more amounts from a buyer in providing results; costs for variable time frames (1, 3, 5 years, etc.) as desired, and other cost and other variables as desired.

Embodiments may utilize dealer information as well. So for example, embodiments may include, whether through databases, calculations, etc. a dealer's cost, percent, dollar amount, and other price numbers relative to a desired sales price, an finical and/or inventory target, costs and prices of various trim levels and/or accessories, and/or other information as may be desired by the dearer for the dealer's internal consumption.

Server 250, and other servers as described herein, is used to mean hardware or software servers of any number and any type as known in the art, and may be local, networked, available through a distributed architecture, as otherwise known in the art, etc.

Server 250 may also, in embodiments, provide output to output device 300 for manual review by a buyer and/or provide output for subsequent processing and/or use by automated processes or apparatus as desired. So, for example, in an embodiment where it is desired to provide output regarding a comparison of a manufacturer's registered vehicles to less costly available new models, said output may be provided to an automated financing process, so as to maximize financing terms and thus adjust available models to provide greater scope of alternatives, as in an inventory control situation, simulation of potential sales levels for various pricing points, etc.

The output device is as known in the art in various embodiments, that is, an output device in a particular embodiment may be any type of device known in the art to provide data for perception by a user, including screens, printouts, etc. and may be local, networked, available through a distributed architecture, server side, client side, as otherwise known in the art, etc.

Output may be comprised of data in any number of formats as are known in the art. For example, embodiments may provide as output, to an individual, a total monthly cost for his or her current vehicle, utilizing such data as financing amount, from a financing database, gas cost based on the vehicle's mpg, from a manufacturer's database, repair cost based on repair estimates from a third party consumer database, etc. and compare that total monthly cost to another vehicle or vehicles that have a lower monthly cost than a potential buyer's current vehicle, and do so using display, print, etc. media, as is known in the art. For example, embodiments may provide a dealer with all customers in a given group and/or database that can get a new car for the same or less monthly cost as their current car. For example, an embodiment may provide to a dealer sales and other target information based on various price and profit levels.

Embodiments may, as well, provide as output a user dependent presentation or personalized presentation for a user showing such data as new vehicle advantages, with, if desired, a side by side comparison of their current vehicle and one or more possible new vehicles, various features such as trim equipment, length of warranty, miles, mpg, airbags, and other criteria (e.g., functions, awards, accreditations, type of financing, possible promotions, other incentives, and other as known in the art as desired. Embodiments may provide for various time frames as well, with various cost numbers as desired, for example, a cost comparison over a three year window, a five year window, etc. Embodiments may provide for various end options as desired, for example, a lease option may well be presented with options at the end of lease, such as a lump sum residual payoff with projected gas, repair and other costs as desired, financing the end of lease vehicle with other potential costs as desired, walking away from the vehicle at lease end and moving to a newer vehicle with associated costs, etc. Embodiments may provide different user dependent presentations of course, while including at least in part, similar or the same data, such as where for example, a seller (e.g., dealership, salesperson, etc.) and buyer (e.g. individual) may desirously seek information about a proposed transaction between them.

Embodiments may be provided as desired; on demand, at a predetermined time interval(s) and/or otherwise as desired. For example, if interest rates change, cost comparisons may be desirably created, if mid year incentives are offered, cost comparison may be desirably created, if new models are released, new trim levels, new options, etc. may, if desired, lead to new costs, comparisons being provided. Additionally, embodiments may provide for an undeniable offer and/or other helpful displays/printouts and the like, to a potential buyer.

It should be noted that embodiments may, as desired, use other inputs as well. So for example, embodiments may provide for input based on a desired purchase price, or monthly cost, monthly payments, etc. of a potential buyer and compare such input to possible purchase options, with an output providing vehicles falling under that amount, what payment terms might be, types of vehicles, etc. Embodiments might also provide such information on a regular basis (and/or on demand.)

Input device 350 is for providing access to server 250, as is known in the art. Thus input device 350 may generate commands to server 250 for various types of information retrieval from various databases. Input devices 350, and output device 300, comprise, in various embodiments, a user interface or user interfaces as is known in the art, as well as any device necessary to support the interface. So, for example, a user interface for an output device comprises, in an embodiment, a visual display upon a screen for supporting the interface, accessible by a user with a World Wide Web browser, and an user input device in the same embodiment may comprise one or more entry fields for providing user input supported by a keyboard, mouse, etc. as known in the art.

User interfaces may be configured to be compatible with various user operating systems, applications and/or devices as desired. So, for example, a user Interface may be used that is compatible with a World Wide Web Browser on a desktop computer; a tablet; smart phone, etc.

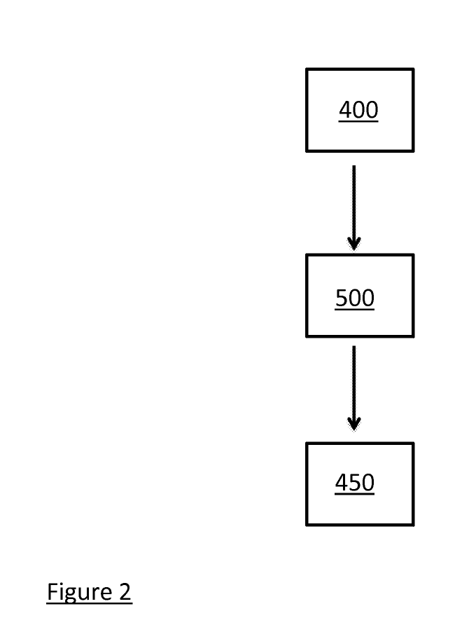

FIG. 2 shows a flow chart of an embodiment for example as used by a dealer. 400 is the process for drawing down vehicle cost structure data from the databases to be used in the embodiment. It should be noted that embodiments may provide for data selection as desired, e.g., to produce a different output for a sales person as compared to a potential buyer, dealer management, manufacturer analysts, or other authorized persons, departments, entities, etc. The data is combined and/or analyzed at 500 via a server. In this embodiment the serer provides a database as well, which may or may not include data from the other buyer side and seller side databases.

Input may be available as well if desired, for search parameters, output contents, configurations, etc. other data to be added and/or used in the process, etc. as shown at 450. The output, which may be different as between the seller (e.g., salesperson) and the potential buyer, is then available via output for each, the seller and the potential buyer, according to various output device parameters.

Embodiments include article(s) of manufacture, as known in the art, for providing the desired output, via the output device to a user comprising an ultimate potential buyer, for example, a printout (not shown) with the potential buyers' current costs, drawn from said data, as well as a comparison to a predetermined vehicle's data. As another example, a dealer may have an embodiment that provides to a customer a printout, email or the like, delivered via a customer delivery channel as is known in the art, e.g., printout, hand delivery, email, mailing, promotional, advertising and marketing materials, etc.

Other embodiments may provide manufacturers, wholesalers, and others with an inventory control device, simulation, forecasting tools and other desired tools. So for example, a manufacture may have available buyer side and seller side databases. By providing for various interest rate scenarios, a manufacturer may be able to forecast demand for its vehicles based on those changes, using the “buyer side” data to assist in determining pricing points, so that, for example, at an interest rate of X%, Y amount of buyers would be provided with financial options that could make purchasing a new car attractive, while, with an interest rate of X1%, Y1 amount of buyers would be provided with financial options that could make purchasing a new car attractive. Of course, any data as desired could be used in such as embodiment.

Embodiments may be implemented on any platform known in the art. Embodiments may comprise an article of manufacture, or signal-bearing medium, containing computer readable code and may be implemented with any combination of hardware and software.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

Moreover, those skilled in the art will appreciate that embodiments may be practiced with electronic device and computer system configurations as known in the art, including computers, tablets, smartphones, other wired and wireless communication devices, and microprocessor-based or programmable consumer electronics.

We claim:

1. A computer-based apparatus for extracting, providing and/or reviewing data, including buyer and seller data, comprising:
a first database for providing vehicle cost structure data further comprising buyer side data;
a second database for providing vehicle cost structure further comprising seller side data;
a server; and,
an output device wherein said output from said output device comprises vehicle cost structure data provided via said server, utilizing said data provided by said first and second databases.

2. A computer-based apparatus as in claim 1 wherein said first and/or second databases are chosen from the group consisting essentially of data warehouses, data marts, operational datastores, local databases, content aggregators, web services, raw data, real time data, line data feed from sensors and the like, and raw data generators.

3. A computer-based apparatus as in claim 1 wherein said buyer side data is chosen from the group consisting essentially of potential buyer data, potential buyer financial data, potential buyer vehicle data, potential buyer and dealership contacts data; potential buyer sales history data, potential buyer location and/or registration data, potential buyer financing data, and potential buyer data provided by a third party.

4. A computer-based apparatus as in claim 1 wherein seller side data is chosen from the group consisting essentially of potential new vehicle model identification data, further comprising name, model types, trim levels, manufacturer, and/or year, cost and pricing data further comprising retail, wholesale, fleet, incentivized, promotional, marketing, leasing, residual, rental, time, interest rate, financing, financing alternative, options, warranty, anticipated gas cost, anticipated repair costs, reliability, and/or anticipated insurance cost data.

5. A computer-based apparatus as in claim 1 further comprising a third party database.

6. A computer-based apparatus as in claim 1 wherein said server for providing said data from said first and/or second database further comprises a server for providing access to the data held in the databases and/or analyzing and/or utilizing said data.

7. A computer-based apparatus as in claim 6 wherein said server for providing said data from said first and/or second database further comprises building and maintaining a database.

8. A computer-based apparatus as in claim 6 wherein said server for providing said data from said first and/or second database further comprises providing access to one or more databases.

9. A computer-based apparatus as in claim 7 wherein said server for providing said data from said first and/or second database further comprises building and maintaining a database further comprised of buyer side database data and/or seller side database data.

10. A computer-based apparatus as in claim 1 wherein said output from said output device comprises vehicle cost structure data provided via said server, wherein said vehicle cost structure data further comprises:
a first total monthly cost for a potential buyer's current vehicle, calculated from and/or including data, which data further comprises financing amount, gas and repair costs;
a second total monthly cost for another vehicle calculated from and/or including data comprising financing amount, gas and repair costs;
wherein said another vehicle has a monthly cost less that said potential buyer's current vehicle.

11. A computer-based apparatus as in claim 10 wherein said another vehicle comprises more than one another vehicle.

12. A computer-based apparatus as in claim 1 further comprising an input device for providing input to said server.

13. A computer-based method for extracting, providing and/or reviewing data, comprising vehicle cost structure data including buyer and seller data, comprising:
providing, from a first database for providing vehicle cost structure data, buyer side data, to a first server;
providing, from a second database for providing vehicle cost structure data, seller side data, to a second server;
providing, from said first and/or second server, selected data from said first and/or second databases, wherein said data is selected according to input parameters, to an output device.

14. A computer-based method as in claim 13 where said first and second servers are the same server.

15. A computer-based method as in claim 13 wherein said first and/or second server analyzes and/or utilizes said selected data.

16. A computer-based method as in claim 13 wherein said first and/or second server analyzes and/or utilizes said selected data.

17. A computer-based method as in claim 13 further comprising providing an undeniable offer to said output device.

18. An article of manufacture comprising:
output, on a user perceptible medium, comprising vehicle cost structure data, wherein said vehicle cost structure data further comprises:
a first total monthly cost for a potential buyer's current vehicle, calculated from and/or including data, which data further comprises financing amount, gas and repair costs;
a second total monthly cost for another vehicle calculated from and/or including data comprising financing amount, gas and repair costs;
wherein said another vehicle has monthly cost less that said potential buyer's current vehicle.

19. An article of manufacture as in claim 18 wherein said output further comprises an undeniable offer.

20. An article of manufacture as in claim 18 wherein said data comprises buyer side data and is chosen from the group consisting essentially of potential buyer data, potential buyer financial data, potential buyer vehicle data, potential buyer and dealership contacts data; potential buyer sales history data, potential buyer location and/or registration data, potential buyer financing data, and potential buyer data provided by a third party.
